(19) United States
(12) Patent Application Publication
(10) Pub. No.: US 2009/0239435 A1
(43) Pub. Date: Sep. 24, 2009

(54) PROTECTIVE SUIT AND METHODS OF MANUFACTURE THEREOF

(75) Inventors: Gary Davis, Albany, NY (US); Joshua Stone, Worcester, NY (US); Hieu Duong, Rosemead, CA (US); Vishal Bansal, Overland Park, KS (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/051,194

(22) Filed: Mar. 19, 2008

(51) Int. Cl. B32B 5/18; B32B 5/24; B32B 27/00; B05D 5/00

(52) U.S. Cl. 442/223; 428/308.4; 428/319.3; 442/372; 427/243

(57) ABSTRACT

The present disclosure is directed to a composite material comprising one or more layers that are able to bind and deactivate chemical and/or biological agents. The first layer comprises a porous polymer substrate and a nucleophilic organic polymer cross-linked on the surface or within the pores of the porous polymer substrate using a carbamate cross-linking agent, wherein the cross-linked nucleophilic polymer comprises functional groups operative to form a covalent bond with a chemical or biological agent. The composite material is used to manufacture items of protective apparel including chemical-biological protective suits.

### FEDERAL RESEARCH STATEMENT

This invention was made with Government support under Contract No. W911-QY-05-C-0102 awarded by the U.S. Army Soldier Systems Center. The Government has certain rights in the invention.

### BACKGROUND

This disclosure is related to protective suits and methods of manufacture thereof. More specifically, this disclosure relates to chemical-biological protective suits and methods of manufacture thereof.

Chemical-biological protective suits are worn when the surrounding environment may present a potential hazard of exposing an individual to harmful or noxious chemicals, and/or to potentially harmful or fatal biological agents. Exposure to such agents may be the result of accidental release in a chemical manufacturing plant, in a scientific or medical laboratory, or in a hospital; intentional release by a government to attack the military forces of the opposition; and/or release during peacetime by criminal or terrorist organizations with the purpose of creating mayhem, fear and widespread destruction. For these reasons, the development of reliable, adequate protection against chemical and biological warfare agents is desirable.

Historically, the materials used for chemical-biological protective suits have had to trade comfort for protection. That is, those offering more protection were unacceptably uncomfortable, and those being of satisfactory comfort did not offer acceptable protection.

The development of materials that provide adequate protection from harmful chemical or biological agents by restricting the passage of such agents has resulted in the production of materials that characteristically prevent the passage of water vapor. A material that to a substantial extent prevents the transmission of water vapor is termed unbreathable. Due to their unbreathable nature, the use of these materials retards the ability of the human body to dissipate heat through perspiration, resulting in the development of heat stress burden on the wearer. For example, currently commercially available materials generally produce a heat stress burden on the soldier wearing the suit.

Further, currently commercially available chemical and biological protective suits also lack a mechanism to detoxify chemical and biological agents. These types of suits possess adsorptive chemical protective systems that act by adsorbing hazardous liquids and vapors into absorbants thus passively inhibiting them from reaching the individual they are designed to protect. However, a limiting characteristic of these absorbants is that they have a finite ability to adsorb chemicals. A second limiting characteristic of absorbants is that they will indiscriminately adsorb chemical species for which protection is unnecessary, this reducing the available capacity for adsorption of the chemicals to which they were intended to provide protection.

It is therefore desirable to have protective suits that are envisioned lightweight, breathable, robust, and ultimately self-detoxifying against specific agents that are known to present serious threats to those fighting the war on terrorism.

### SUMMARY

Disclosed herein is an article comprising a first layer comprising a porous polymer substrate and a nucleophilic organic polymer cross-linked on the surface or within the pores of the porous polymer substrate using a carbamate cross-linking agent, wherein the cross-linked nucleophilic polymer comprises functional groups operative to form a covalent bond with a chemical or biological agent.

Disclosed herein too is an article comprising a first layer comprising a porous polymer substrate and a nucleophilic organic polymer cross-linked on the surface or within the pores of the porous polymer substrate using a carbamate cross-linking agent; a second layer comprising a porous polymer substrate; and a third layer comprising a woven or a non-woven fabric; wherein the cross-linked nucleophilic polymer comprises functional groups operative to form a covalent bond with a chemical or biological agent.

Disclosed herein too is a method of manufacturing an article comprising disposing a nucleophilic organic polymer on a porous polymer substrate; the porous polymer substrate with the nucleophilic organic polymer disposed thereon forming a first layer; and cross-linking the nucleophilic organic polymer on a surface or within pores of the porous polymer substrates using a carbamate cross-linking agent; wherein the cross-linked nucleophilic polymer comprises functional groups operative to form a covalent bond with a chemical or biological agent.

### BRIEF DESCRIPTION OF THE DRAWINGS

FIG. 1 provides an illustration of the bonding that occurs between a chemically reactive group on a nucleophilic polymer, in this case ethoxylated polyethyleneimine (PEI-OH), and a chemical agent such as sarin;

FIG. 2 shows a schematic layering of the composite material that comprises the first layer and an optional second layer;

FIG. 3 is an illustration of a multi-layered composite material comprising a first layer, a second layer and a third layer;

FIG. 4 is an illustration of a multi-layered composite material comprising a first layer, a second layer, a third layer, and an additional activated carbon layer disposed between the first layer and the second layer;

FIG. 5 is an illustration of a multi-layered composite material comprising a first layer, a second layer, a third layer, and an additional activated carbon layer disposed between the second layer and the third layer;

FIG. 6 is an illustration of a multi-layered composite material comprising a first layer and a third layer, with an additional activated carbon layer disposed between the first layer and the third layer;

FIG. 7 is a graph representing the permeation testing results for the Comparative Sample #1;

FIG. 8 is a graph representing the permeation testing results for the inventive Sample #1 of this disclosure; and

FIG. 9 is a chromatograph comparing the solid state ³¹P NMR results for the Comparative Sample #1 with the Sample #1.

### DETAILED DESCRIPTION

The terms “a” and “an” as used herein do not denote a limitation of quantity, but rather denote the presence of at least one of the referenced item. All ranges disclosed herein are inclusive and combinable.

The terms “comprises” and/or “comprising,” as used herein, specify the presence of stated features, integers, steps, operations, elements, and/or components, but do not preclude the presence or addition of one or more other features, integers, steps, operations, elements, components, and/or groups thereof.

As used herein, the term “biological agent” refers to a microorganism, such as a virus or bacteria, capable of causing morbidity or mortality in humans, or in animals. The term “biological agent” also encompasses toxins that are produced by such microorganisms, and which may be purified and used independently from the microorganism.

It will be understood that when an element or layer is referred to as being “on,” “interposed,” “disposed,” or “between” another element or layer, it can be directly on, interposed, disposed, or between the other element or layer, or intervening elements or layers may be present.

As used herein, the terms first, second, third, and the like may be used herein to describe various elements, components, regions, layers and/or sections, however, these elements, components, regions, layers and/or sections should not be limited by these terms. These terms are only used to distinguish one element, component, region, layer or section from another element, component, region, layer or section. Thus, first element, component, region, layer or section discussed below could be termed second element, component, region, layer or section without departing from the teachings of the present invention.

The present disclosure is directed to a composite material that is selectively impermeable to chemical and biological agents. The composite material described herein comprises one or more layers that are able to bind and deactivate chemical and/or biological agents. In an exemplary embodiment, the composite material comprises a plurality of layers that are able to absorb certain chemical and/or biological agents in addition to being capable of binding and deactivating other chemical and/or biological agents. The multilayered composite is used for the manufacture of protective coverings, including chemical-biological protective suits.

In one embodiment, the composite material comprises a first layer that comprises a porous polymer substrate and a nucleophilic organic polymer cross-linked on the surface or within the pores of the porous polymer substrate using a cross-linking agent. Specifically, the material is comprised of pores that are interconnected throughout the thickness of the material or surface from one side to the other. The presence of the pores allows for the movement of liquid or gas through the material. The pores may be open or closed cell pores. It is desirable for the composite material to have open cell pores.

Various types of polymers can be used to form the porous polymer substrate. Examples of polymers that can be used include those selected from the group consisting of polyolefins, polyamides, polycarbonates, cellulosic polymers, polyurethanes, polyesters, polyethers, polyacrylates, copolyether esters, copolyether amides, chitosan, fluoropolymers, and a combination comprising at least one of the foregoing polymers. Specifically, the porous polymer substrate can be a fluoropolymer selected from the group consisting of polytetrafluoroethylene, poly(vinylidene fluoride), poly(vinylidene fluoride co-hexafluoropropylene), poly(tetrafluoroethylene oxide-co-difluoromethylene oxide, poly(tetrafluoroethylene-co-perfluoro(propylvinyl ether)), and a combination comprising at least one of the foregoing fluoropolymers. More specifically, the porous polymer substrate can be porous polytetrafluoroethylene, and even more specifically, a substrate of expanded porous PTFE (ePTFE).

The polymer may be rendered porous by, for example, methods selected from the group consisting of perforating, stretching, expanding, bubbling, or extracting the polymer material, and a combination comprising at least one of the foregoing methods. Methods of making the porous polymer substrate can also include foaming, skiving or casting any of the materials. In one embodiment, the porous polymer substrate is prepared by extruding a mixture of fine powder particles and lubricant. The calendered extrudate can be expanded or stretched in one or more directions to form fibrils that are connected to nodes, to form a 3-dimensional matrix or lattice type of structure. In one embodiment the term “expanded” means stretched beyond the elastic limit of the material to introduce permanent set or elongation to the fibrils.

Continuous pores can be produced throughout the substrate. The porosity of the substrate can be greater than or equal to about 10 weight percent by volume. Specifically, the porosity can be in a range of from about 10 weight percent to about 90 weight percent. The pore diameter can be uniform from pore to pore, and the pores can define a regular, periodic pattern. Alternatively, the pore diameter can differ from pore to pore, and the pores can define an irregular, aperiodic pattern. Combinations or pores that have regular, irregular, periodic and aperiodic patterns may also be used in the porous polymer substrate. The diameter of the pores can be less than or equal to about 50 micrometers (μm). Specifically, the diameter of the pores can be about 0.01 μm to about 50 μm.

The porous polymer substrate can be a three-dimensional matrix or have a lattice-type structure comprising a plurality of nodes interconnected by a plurality of fibrils. Surfaces of the nodes and fibrils define a plurality of pores in the substrate,

In one embodiment, a polymerizable nucleophilic organic polymer and a cross-linking agent are disposed upon the porous polymer substrate of the first layer. The nucleophilic organic polymer forms a thin coating or film on the surface of the porous polymer substrate. Additionally, a solution comprising the nucleophilic organic polymer can be used to partially or fully impregnate the pores of the porous polymer substrate. Upon coating, the nucleophilic organic polymer is cross-linked in situ to the opposing surfaces of the porous polymer substrate and/or within the pores of the porous polymer substrate.

Examples of nucleophilic organic polymers are selected from the group consisting of polyalkyleneimines, for example, polyethyleneimine; polyamines, for example polyvinylamine, and polyallylamine; polyvinyl alcohols; polyesters, polyamides, polyalkylene glycol derivatives, for example, polyethylene and polypropylene glycol derivatives and amine-substituted polyethylene and substituted polyacrylates; functionalized olefin polymers; copolymers of polyvinylamine and polyvinylalcohol; and a combination comprising at least one of the foregoing nucleophilic polymers. Specifically, polyethyleneimines can be used including branched or linear polyethyleneimine, acylated polyethyleneimine, or ethoxylated polyethyleneimine. More specifically, ethoxylated polyethyleneimine (PEI-OH) can be used as the nucleophilic organic polymer.

The cross-linking agent used to cross-link the nucleophilic organic polymer is selected for its ability to cross-link the nucleophilic organic polymer and thereby facilitate the adhesion of the nucleophilic organic polymer to the porous polymer substrate. In one embodiment, the cross-linking of the nucleophilic organic polymer prevents the removal of the cross-linked nucleophilic organic polymer from the porous polymer substrate.

Examples of cross-linking agents include those selected from the group consisting of carbamates, blocked and unblocked isocyanates, polymeric polyepoxides, polybasic esters, aldehydes, formaldehydes and melamine formaldehydes, ketones, alkylhalides, organic acids, ureas, anhydrides, acyl halides, chloroformates, acrylonitrites, acrylates, methacrylates, dialkyl carbonates, thioisocyanates, dialkyl sulfates, cyanamides, haloformates, and a combination comprising at least one of the foregoing cross-linkers. Specifically, carbamates, also known as urethanes, are selected as cross-linking agents. More specifically, the carbamate is a 1,3,5-triazine carbamate.

In one embodiment, the 1,3,5-triazine carbamate cross-linker is a material having the Formula I, wherein R is independently at each occurrence a C1 to C8 alkyl. Specifically, the R group is a methyl or a butyl. More specifically, the 1,3,5-triazine carbamate cross-linkers have a methyl to butyl molar ratio of about 60:40.

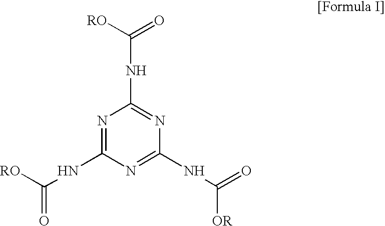

Examples of 1,3,5-triazine carbamate cross-linkers having the above formula are selected from the group consisting of tris-(butoxycarbonylamino)-1,3,5-triazine, tris-(methylcarbonylamino)-1,3,5-triazine, and mixed tris-substituted (methoxylbutoxycarbonylamino)-1,3,5-triazine systems.

The nucleophilic organic polymer and the cross-linking agent are combined together in a solvent to form a solution, which is then applied to the porous polymer substrate. The solution can be applied to the porous polymer substrate using a variety of methods including dipping, spraying, padding, brushing, flowcoating, electrocoating, slot die coating, or electrostatic spraying. Specifically, slot die coating methods can be effectively used. Thereafter, the material may be cured by application of heat at a temperature and for a length of time sufficient to facilitate the cross-linking reaction, and to evaporate any residual solvent. The heating can occur in an oven following the coating process or, by setting the temperature of the rolls used in a roll-to-roll, or slot die process, to a level sufficient to both dry off the solvent and cross-link the nucleophilic organic polymer.

The nucleophilic organic polymer can be used in an amount of about 1 to about 95 weight percent based upon the total weight of the solution. Specifically, the nucleophilic organic polymer can be used in an amount of about 5 to about 60 weight percent, and more specifically in an amount of about 20 to about 40 weight percent. The cross-linker can be used in an amount of about 0.1 weight percent to about 50 weight percent based on the total weight of the solution. Specifically, the crosslinker can be used in an amount of about 1 to about 20 weight percent, and more specifically, in an amount of about 5 to about 15 weight percent.

In one embodiment, the cross-linked nucleophilic polymer forms a coating on the surface of the porous polymer substrate. The thickness of the cross-linked nucleophilic polymer coating can vary in order to provide the desired degree of protection. Further, the thickness of the applied coating is directly related to the weight of cross-linked nucleophilic polymer applied. Specifically, the weight of the cross-linked nucleophilic polymer coating applied to the porous polymer substrate is about 1 to about 15 milligrams per square centimeter (mg/cm²). The coating can be uniform in thickness or have a thickness that varies from one area to another. In another embodiment, the cross-linked nucleophilic polymer is impregnated within the pores of the porous polymer substrate. In yet another embodiment, the cross-linked nucleophilic polymer can be simultaneously coated on both the surface of the porous polymer substrate and within the pores of the porous polymer substrate.

As described heretofore, the cross-linking agent is selected for its ability to cross-link the nucleophilic organic polymer in order to facilitate the entanglement of the nucleophilic polymer in and around the pores of the porous polymer substrate, thereby forming a stable coating on the surface and/or within the pores of the porous substrate. Additionally, the cross-linking agent can also be selected for its ability to incorporate chemically reactive functional groups in the nucleophilic polymer. These functional groups have the ability to bind chemical or biological agents.

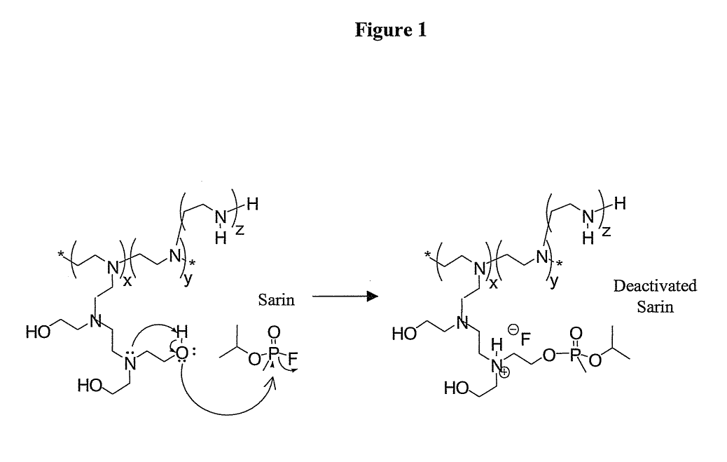

In one embodiment, the cross-linked nucleophilic organic polymer of the first layer comprises functional groups operative to form a covalent bond with a chemical or a biological agent. The binding of a chemical or biological agent can be to a reactive group present on the nucleophilic polymer prior to the cross-linking reaction. Alternatively, the binding of a chemical or biological agent can be to an unreacted functional group provided to the cross-linked nucleophilic polymer by the cross-linking agent. FIG. 1 provides an illustration of the covalent bonding that can occur between a chemically reactive group on a nucleophilic polymer, in this case ethoxylated polyethyleneimine (PEI-OH), and a chemical agent such as sarin. For example, as shown in FIG. 1, one possible mechanism is the hydrolysis of the nerve agent sarin and the formation of a covalent bond with the hydroxyl group on the PEI-OH molecule. Alternatively, the covalent bond between sarin and PEI-OE may form as a consequence of a nucleophilic attack by the nitrogen instead of the oxygen. As a result of this covalent interaction between the toxin and the cross-linked nucleophilic polymer, the sarin molecule is not only bound to the surface of the nucleophilic polymer, but is also deactivated, and is therefore no longer capable of exerting a toxic effect. Thus, rather than simply absorbing or blocking a chemical or biological agent, the first layer comprising a porous polymer substrate and a cross-linked nucleophilic polymer, is capable of deactivating agents that come into contact with the layer.

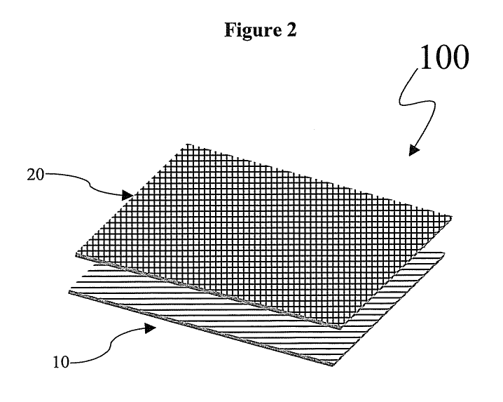

In one embodiment, the composite material comprises the first layer comprising the porous polymer substrate described above and an optional second layer adjacent to, or disposed on, the first layer. FIG. 2 shows a schematic layering of the composite material 100 that comprises the first layer 10 and the optional second layer 20.

The optional second layer 20 comprises a porous polymer substrate. The porous polymer substrate comprising the optional second layer 20 can be composed of the same polymer material as is present in the first layer 10. Alternatively, the porous polymer substrate of the second layer 20 is made from a polymer that is different from the first layer 10. In one embodiment, the porous polymer substrate of the second layer 20 is unmodified i.e., it comprises a nucleophilic polymer that is not cross-linked on the surface or in the pores. In another embodiment, the second layer 20 comprises a porous polymer substrate further comprising a cross-linked nucleophilic organic polymer.

In one embodiment, the composite material comprises an optional third layer comprising a fabric material. The optional third layer is generally disposed on a surface of the second layer 20 that is opposed to the surface on which the first layer is disposed; i.e., the first layer and the third layer are disposed on opposing surfaces of the second layer. The fabrics of the third layer can be made from woven or non-woven material. Fabrics may be prepared from any synthetic or natural fiber appropriate for the specific end use in mind. Examples of fabrics include those used selected from the group consisting of polyamides, polyesters, cotton, aramids, and a combination comprising at least one of the foregoing fabrics. Specifically, the fabric can be a cotton/nylon mix in an amount of about 50 parts cotton to about 50 parts nylon and with a durable water-repellent finish.

Additional additives can be included in the composite material to further enhance the ability of the multilayered composite material to bind and inactivate chemical and biological agents. Examples of such agents include antimicrobial agents, enzymes with activity for known chemical and/or biological agents, and chemical absorbing agents. The additional additives can be selectively disposed upon the first, second or third layers.

In one embodiment, antimicrobial agents can be incorporated into one or more of the layers. As used herein, an “antimicrobial” agent is an agent that has antiviral (kills or suppresses the replication of viruses), antibacterial (bacteriostatic or bactericidal), and/or antifungal properties (kills or suppresses replication of fungi). Thus, the incorporation of one or more antimicrobial agents into the composite material provides an additional mechanism, acting in concert with the first layer, to kill, deactivate, or suppress the growth of microbial agents, such as bacteria, and viruses.

In one embodiment, antimicrobial compounds such as quaternary ammonium salts, N-halamines, antimicrobial metals and/or antimicrobial metal oxides can be coated directly on a surface of the first layer, or on a surface of the second layer, or optionally incorporated into the fabric of the third layer. Examples of quaternary ammonium salts having antimicrobial activity include those selected from the group consisting of tetraalkylammonium fluoroborates, alkylpyridinum fluoroborates, cetylpyridinium chloride (CPC), dodecyltrimethyl ammonium bromide (DTAB), N-(3-chloro-2-hydroxypropyl)-N,N-dimethyldodecylammonium chloride, 1,3-Bis-(N,N-dimethyldodecylammonium chloride)-2-propanol, dodecyltrimethyl ammonium chloride (DTAC), N-(1-(2,3-dioleoyloxy)propyl)-N,N,N-trimethylammonium chloride (DOTAP), N-(1-(2,3-dioleyloxy)propyl)-N,N,N-trimethylammonium chloride (DOTMA), dimethyldioctadecyl ammonium bromide (DDAB), N,N-dioleyl-N,N-dimethylammonium chloride (DODAC), 1,2-dioleoyloxy-3-(N,N,N-trimethylamino)propane chloride (DOTAP), and a combination comprising at least one of the foregoing quarternary salts. Examples of antimicrobial metals include those selected from the group consisting of silver (Ag), gold (Au), platinum (Pt), palladium (Pd), iridium (Ir), tin (Sn), copper (Cu), anitmony (Sb), bismuth (Bi), zinc (Zn), and a combination comprising one or more of the foregoing antibacterial metals. Specifically, antimicrobial metals such as Ag, Au and Cu can be used. Alternatively, antimicrobial metals compounds can be used, and include those selected from the group consisting of metal oxides, metal-containing ion-exchange compounds, metal-containing zeolites, metal-containing glass, and a combination comprising at least one of the foregoing metal compounds. Specifically, metal oxides can be used. Examples of metals oxides include those selected from the group consisting of AgO, TiO₂, Al₂O₃, MgO, CuO, and a combination comprising at least one of the foregoing metal oxides.

A “metallic stream” of antimicrobial metal or metal compound may be deposited onto the surface of the first and/or second layer in several different ways. Specifically, physical vapor deposition (PVD) techniques can be used to deposit the metals onto the surface of the first or second layer. Physical vapor deposition techniques deposit the metal from a vapor, generally atom by atom, onto a substrate surface. PVD techniques include, those selected from the group consisting of vacuum or arc evaporation, thermal vapor deposition, sputtering, and magnetron sputtering.

In another embodiment, the fabric used in the third layer can also be surface-treated with enzymes having activity for well-known chemical warfare agents. The enzymes can be selected for their ability to enzymatically degrade chemical agents such as sarin, soman, tabun, mustard agents, VX and Russian VX nerve agents. Examples of such enzymes include those selected from the group consisting of organophosphorus hydrolase (OPH), organophosphorus acid anhydrolase (OPAA), and diisopropylfluorophosphatase (DFPase) enzymes, and a combination comprising at least one of the foregoing enzymes. The aforementioned enzymes can be immobilized on the surface of the fabric used in the third layer and retain their ability to inactivate and/or degrade known chemical agents, thereby providing a preliminary layer of protection against such agents.

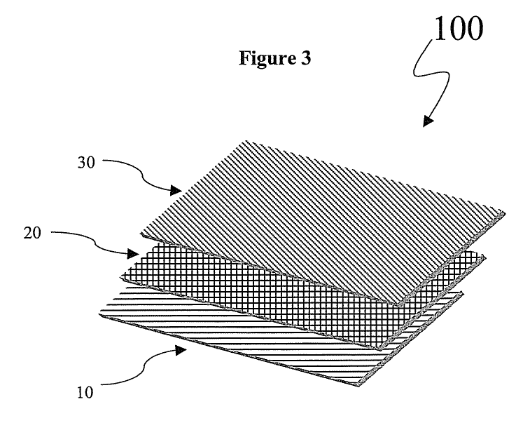

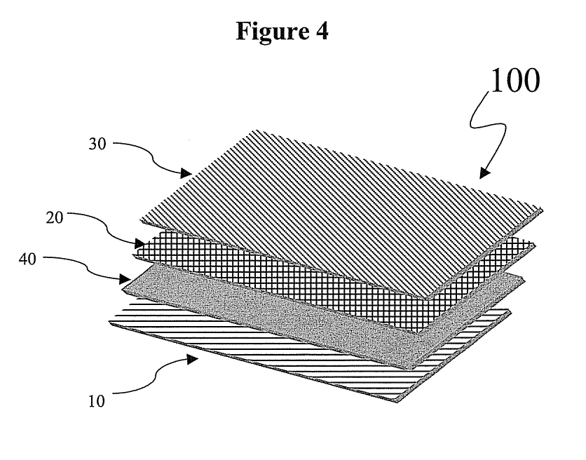

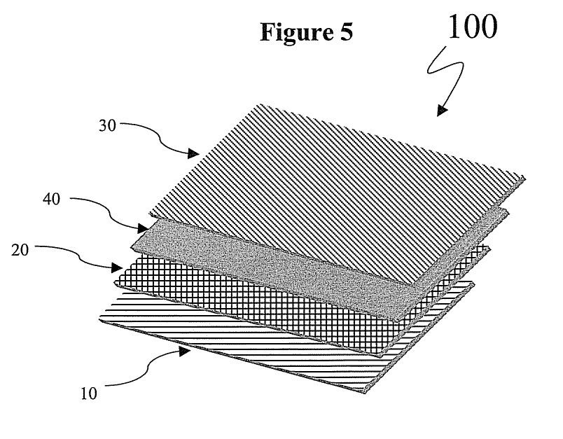

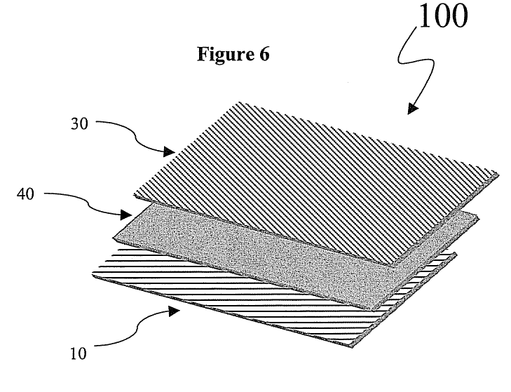

In yet another embodiment, an optional layer of chemically absorbant material such as activated carbon, is inserted in the composite material. The activated carbon layer can be disposed on, or adjacent to, a single first layer (i.e., the activated carbon layer replaces the second or third layer); interposed between the first layer and an optional second layer; or interposed between a second layer and an optional third layer. Alternatively, in the absence of the optional second layer, the activated carbon layer is interposed between the first layer and the third layer. FIGS. 3, 4, 5, and 6 are schematic representations of the multilayered composite materials 100. In the FIG. 3, the second layer 20 is interposed between the first layer 10 and the third layer 30 and contacts the first layer 10 and the third layer 30. The FIG. 4 shows an activated carbon layer 40 interposed between the second layer 20 and the third layer 30, while the FIG. 5 shows an alternate structure wherein the activated carbon layer 40 is interposed between the first layer 10 and the second layer 20. Finally, FIG. 6 shows the activated carbon layer interposed between the first layer 10 and the third layer 30.

The activated carbon can be impregnated in a carrier such as foam, fabric, felt, or paper, and in this form is termed activated carbon fiber (ACF). The activated carbon absorbers can be incorporated directly into the fibers of the carrier. Alternatively, spherical activated carbon absorbers can be adhered to a textile carrier with an adhesive binder or resin. ACF materials are characterized by their ability to absorb large volumes of gas, their heat-resistance, and by their resistance to both acids and bases. ACF materials are able to non-specifically absorb a wide variety of materials such as organic vapors, for example, gasoline, aldehydes, alcohols and phenol; inorganic gases, for example, NO, NO₂, SO₂, H₂S, HF, HCl, and the like; and substances in water solution, for example, dyes, COD, BOD, oils, metal ions, precious metal ions); and bacteria. Specifically, composite filter fabrics based on highly activated and hard carbon spheres fixed onto textile carrier fabrics, such as the SARATOGA™ fabrics can be used. Thus, the inclusion of an activated carbon layer can provide an additional barrier to noxious gases and thereby increase the ability of the composite material to filter out non-specific chemical agents.

In one embodiment, the composite material comprising at least one or more layers, is selectively permeable. For this reason, the composite material is able to effectively filter out chemical and biological agents while still maintaining a Moisture Vapor Transport Rate (“MVTR”) of about 1 to about 12 kilograms per square meter per 24 hours (kg/m²/24 h), specifically up to about 6 kg/m²/24 h, and more specifically up to about 8 kg/m²/24 h, while the transport rate of materials harmful to human health is low enough to prevent the occurrence of injury, illness or death.

In another embodiment, the layered composite material can be used for the fabrication of, or as a component in, a variety of articles of manufacture, including articles of protective apparel, especially for clothing, garments or other items intended to protect the wearer or user against harm or injury as caused by exposure to toxic chemical and/or biological agents.

In yet another embodiment, the item of protective apparel is a chemical-biological protective suit useful to protect military personnel and first responders from known or unknown chemical or biological agents potentially encountered in an emergency response situation. Alternatively, the item is intended to protect cleanup personnel from chemical or biological agents during a hazardous material (HAZMAT) response situation or in various medical applications as protection against toxic chemical and/or biological agents.

Examples of items of protective apparel include those selected from the group consisting of coveralls, protective suits, coats, jackets, limited-use protective garments, raingear, ski pants, gloves, socks, boots, shoe and boot covers, trousers, hoods, hats, masks and shirts.

In another embodiment, the composite material can be used to create a protective cover, such as for example, a tarpaulin, or a collective shelter, such as a tent, to protect against chemical and/or biological warfare agents.

Articles comprising the composite material described herein have the ability to bind and deactivate a wide variety of chemical and biological agents. Examples of chemical agents include those selected from the group consisting of nerve agents, for example, Sarin, Soman, Tabun, and VX; vesicant agents, for example, sulfur mustards; Lewisites such as 2-chlorovinyldichloroarsine; nitrogen mustards; tear gases and riot control agents; and a combination comprising at least one of the foregoing chemical agents. Examples of potential biological agents include those selected from the group consisting of viruses, for example smallpox, encephalitis-causing viruses, and hemorrhagic fever-causing viruses; bacteria, for example, Yersinia pestis, Vibrio cholerae, Francisella tularensis, Rickettsia rickettsii, Bacillus anthracis, Coxiella burnetii and Clostridium botulinum; and toxins, for example, Ricin, Staphylococcal enterotoxin B, trichothecene mycotoxins, and Cholera toxins; and a combination comprising at least one of the foregoing biological agents. Examples of hazardous materials in addition to those listed above include certain pesticides, particularly organophosphate pesticides.

In one embodiment, a method is provided for manufacturing an article comprising the composite material. The layers of the composite material can be assembled together by any suitable means whereby the assembly is designed to perform as a whole that which the individual layers perform in part. Methods that can be used to manufacture an article from the composite material include, assembly of the layers with discontinuous bonds such as discrete patterns of adhesive or point bonding, mechanical attachments such as sewn connections or other fixations, fusible webs and thermoplastic scrims, direct coating on, or within, partially or entirely, the various layers in such a manner as they are intended to function in conjunction with one another.

Since the composite material described herein is both thinner and lighter than materials presently used for other commercially available suits, and since the MVTR of the composite material is good, articles manufactured from the composite material will be lighter and more comfortable to wear than those that are presently available. Combined with the ability of the composite material to bind and deactivate chemical and/or biological agents, articles made from the composite material will provide a comfortable and effective barrier for those in need of protection from hazardous agents.

### EXAMPLES

The following examples are intended only to illustrate methods and embodiments in accordance with the invention and as such should not be construed as imposing limitations upon the claims.

### Example 1

This example was conducted to demonstrate the advantages of the disclosed composite material over a comparative material that did not contain the crosslinked nucleophilic organic polymer. The disclosed composite material will hereinafter be referred to as Sample #1, while the sample used for comparison will be referred to as Comparative Sample #1.

Sample #1 was prepared by coating a first layer of expanded polytetrafluoroethylene (ePTFE) with a coating solution, the contents of which are shown in the Table 1. The coating solution was prepared by dissolving the polyetheylenimine polymer in the 2-propanol via mechanical stirring. The crosslinker was then added to the solution once the polymer was dissolved. The solution was then filtered, degassed, and passed through a 40 micrometer inline filter prior to reaching the slot die.

Prior to application of the coating solution, the layer of ePTFE was laminated to polyester to give it structural support when going through the slot die process. The ePTFE membrane was pre-wet with isopropanol, and the ePTFE side of the laminate was then coated with the slot die solution shown in Table 1.

By controlling the shim thickness, flow rates, and the like, the amount of nucleophilic polymer coating can be regulated. For example, the nucleophilic polymer coating can be applied in a single pass or in multiple passes, depending on how much polymer is desired to be applied.

The coated membrane was then heated at 180° C. for about 10 minutes in order to cross-link the PEI-OH with the cross-linker to form the first layer of Sample #1. The heating to 180° C. also acts to evaporate any residual solvent. The polymer treated, ePTFE/polyester laminate, was subsequently laminated with an activated carbon layer from MAST Carbon (C-TEX 13; UK), comprising activated carbon beads woven into a fabric material. A third layer comprising a 50/50 blend of cotton and nylon ripstop fabric was then further laminated to the layer of activated carbon fabric. The final composition of the Sample #1 laminate was thus as follows: top layer comprising 50/50 cotton nylon ripstop fabric; middle layer comprising C-TEX 13 activated carbon fabric and bottom layer comprising Chem-Bio treated ePTFE/polyester prepared by slot die process described above. In another embodiment, the carbon layer can be any type of carbon fabric and can also be the bottom layer instead of the middle layer.

Following assembly of the composite material, the polyester layer was removed from the final architecture as it served no other purpose other than to provide structural support to the ePTFE layer during the coating process.

TABLE 1

| Composition | Weight percent (Wt %) |
|---|---|
| Polyethyleneimine | 40 |
| 1,3,5-triazine carbamate | 20 (wt %) based on the mass of |
| (45 wt % in butanol) | ePTFE/polyester laminate. |
| 2-propanol | 52 |

As noted above, the first layer was laminated with a second layer and a third layer to form the Sample #1.

### Preparation of Comparative Sample #1

Comparative Sample #1 was prepared by laminating a C-TEX 13 activated carbon layer to a layer of 50/50 cotton nylon ripstop fabric for the outer shell.

### Testing of Sample # 1 and Comparative Sample #1 Swatches

Vapor permeation testing of both the Comparative Sample #1 and Sample #1 swatches was conducted in accordance with approved test procedures, methodologies, and equipment as specified in U.S. Army Test Operations Procedure (TOP) 8-2-501/CRDC-SP-84010, “Permeation and Penetration Testing of Air Permeable, Semi-permeable, and Impermeable Materials with Chemical Agents or Simulants” (Swatch Testing). The agent diisopropylfluorophosphate (DFP), a known stimulant for a broad number of nerve agents, was used to evaluate the permeability of the prepared materials.

Swatches having a surface area of 15.2 cm² and comprising the layers of the Sample # 1 or the layers of the Comparative Sample # 1 were placed in a test fixture, then 10 g/m² of liquid DFP was applied to the top surface of each swatch, and the test fixture was sealed. At specified times over a 24 hour (h) period, gas samples were taken from underneath the test swatch. The amount of agent vapor that permeated the test swatch at each of the time points was measured using a highly sensitive and accurate miniaturized gas chromatograph and sampling system (MINICAMS™; OI Analytical, CMS Field Products Group). The amount of agent passing through the swatch was monitored continuously over a period of 24 h, and the total quantity of agent detected was expressed as micrograms per 24 hours (□g/24 h). The MINICAMS detect continuously (about every 2.4 minutes) and as a result provide a continuous permeation profile.

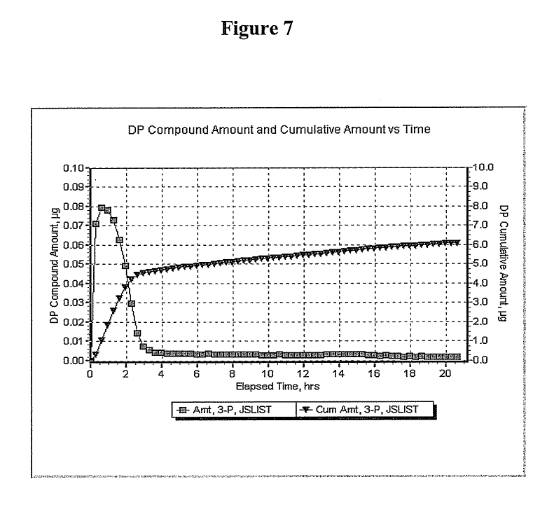

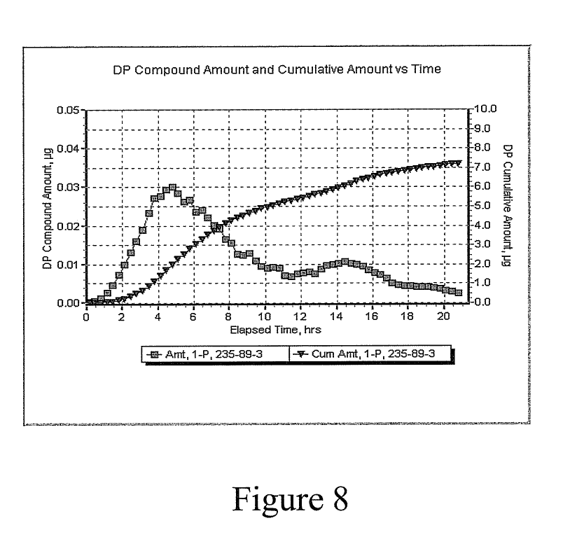

FIGS. 7 and 8 are graphs showing the results of the MINICAMS permeability testing for the Comparative Sample #1 and for Sample #1, respectively. In the FIG. 7, it can be seen that the maximal amount of DFP that breaks through the Comparative Sample # 1 swatch occurs within the first two hours following exposure to the agent. In contrast however, FIG. 8 shows that the maximal amount of detectable DFP that breaks through the Sample #1 swatch, occurs after the 2 hour period and is delayed until 4 to 5 hours after the initial exposure. From the FIGS. 7 and 8, it is clear that the Sample #1 swatch is able to increase the window of time to reach maximal DFP permeability levels by at least 2 hours as compared to the Comparative Sample #1 swatch. Further, it should also be noted that at even at peak penetration (i.e. 5 hours), the amount of DFP that has permeated through the Sample #1 swatch is almost 3 times (2.67) lower than the amount of DFP observed at 2 hours with the Comparative Sample #1.

### Example 2

This example was conducted to demonstrate the difference in functional behavior between the Comparative Sample #1 and the Sample #1.

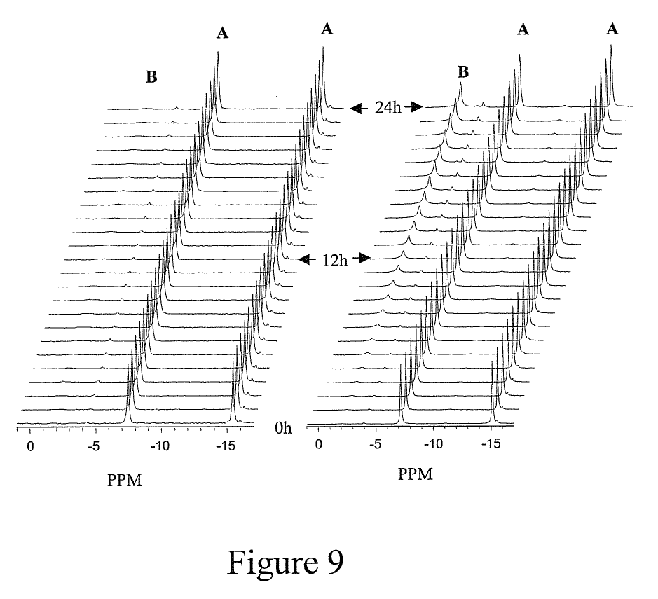

Solid state phosphorus (³¹P) NMR was conducted on the samples containing DHP that permeated through the swatch. FIG. 9 shows the results from the NMR analysis. The peak for “A” as indicated in FIG. 9 corresponds to the Formula A shown below, while the peak for “B” as indicated in FIG. 9, corresponds to Formula B below.

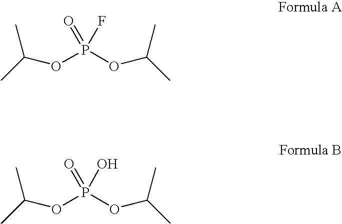

Formula A is the structure for DFP, while Formula B is the structure for DFP that has been hydrolyzed (DHP). The results on the left side of FIG. 9 correspond to the Comparative Sample #1. In the case of the Comparative Sample #1, two peaks representative of Formula A are detected, whereas Formula B is not detected at all. Thus, in the Comparative Example 1, unmodified DFP is the only structure that is detected. In the case of Example 1 (FIG. 9, right side) two peaks corresponding to Formula A are observed. However, third peak corresponding to Formula B begins to appear at about 11 to 12 hours after the initiation of the permeability test. At 24 hours, 31% of the total material detected is attributable to Formula B. Thus in the inventive Sample #1, the DFP is hydrolyzed upon exposure to the PEI-OH cross-linked on the surface of the ePTFE. Results from experiments conducted on subsequently generated samples, show that full hydrolysis of the DFP molecule does occur such that all of the DFP is converted to DHP within a period of 24 hours.

### Example 3

This example was conducted to determine the moisture vapor transfer rate (MVTR) for the Comparative Sample #1 and the Sample #1. The moisture vapor transport rate was measured by a method derived from the Inverted Cup method of MVTR measurement. The test method is JIS L 1099 B-2. Table 2 summarizes the features of the Comparative Sample #1 and Sample #1.

TABLE 2

| Test | Comparative Sample #1 | Sample #1 |
|---|---|---|
| DFP Permeability total | 6.96 ± 3.97 | 10.89 ± 6.42 |
| (μg/24 h) | | |
| Air Permeability (cfm) | 5.3 | 0 (closed pore) |
| MVTR (g/m²/24 h) | 5048 | 4250 |
| Thickness (inches) | 0.05 | 0.01 |
| Weight (oz/yd²) | 18.1 | 6.5 |
| Protection Method | Adsorption | Blocking/Deactivation |

As can be seen in Table 2, Sample #1 is lighter in weight and thinner than the Comparative Sample 1. The MVTR for Sample #1 is about 25% less, indicating its superiority over Comparative Sample #1.

Thus in summary, the composite material disclosed herein shows significantly better MVTR results at lower thicknesses when compared with other commercially available materials used in protective suits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. An article comprising:
a first layer comprising a porous polymer substrate and a nucleophilic organic polymer cross-linked on the surface or within the pores of the porous polymer substrate using a carbamate cross-linking agent, wherein the cross-linked nucleophilic polymer comprises functional groups operative to form a covalent bond with a chemical or biological agent.

2. The article of claim 1, wherein the carbamate cross-linking agent is a 1,3,5-triazine carbamate.

3. The article of claim 1, wherein the nucleophilic organic polymer comprises a polymer selected from the group consisting of polyethyleneimine, polyamines, polyvinyl alcohols, polyesters, polyamides, polyalkylene glycol derivatives, amine-substituted polyethylene and polypropylene glycols, polyacrylates, functionalized olefin polymers, copolymers of polyvinylamine and polyvinylalcohol, and a combination comprising at least one of the foregoing nucleophilic polymers.

4. The article of claim 3, wherein the nucleophilic polymer is ethoxylated polyethylenimine.

5. The article of claim 1, wherein the porous polymer substrate comprises a porous fluorinated polymer selected from the group consisting of polytetrafluoroethylene, poly(vinylidene fluoride), poly(vinylidene fluoride co-hexafluoropropylene), poly(tetrafluoroethylene oxide-co-difluoromethylene oxide, poly(tetrafluoroethylene-co-perfluoro(propylvinyl ether)), and a combination comprising at least one of the foregoing fluoropolymers.

6. The article of claim 5, wherein the porous polymer substrate comprises expanded polytetrafluoroethylene.

7. The article of claim 1, further comprising a second layer that comprises a porous polymer substrate; the second layer being in contact with the first layer.

8. The article of claim 7, further comprising a third layer comprising a woven or a non-woven fabric layer; the third layer being in contact with the second layer.

9. The article of claim 1, further comprising an additive selected from the group consisting of antimicrobial agents, enzymes with activity for chemical and/or biological agents, chemical absorbing agents, and a combination comprising at least one of the foregoing additives.

10. The article of claim 9, wherein the antimicrobial agent is an antimicrobial metal selected from the group consisting of an antimicrobial metal or metal salt; an antimicrobial metal oxide; an antimicrobial metal-containing ion-exchange compound; an antimicrobial metal-containing zeolite; an antimicrobial metal-containing glass; and a combination comprising at least one of the foregoing metal compounds.

11. The article of claim 9, wherein the chemical absorbing agent is activated carbon.

12. The article of claim 9, wherein the enzyme is selected from the group consisting of organophosphorus hydrolase, organophosphorus acid anhydrolase, and diisopropylfluorophosphatase, and a combination comprising at least one of the foregoing enzymes.

13. An article comprising:
a first layer comprising a porous polymer substrate and a nucleophilic organic polymer cross-linked on the surface or within the pores of the porous polymer substrate using a carbamate cross-linking agent;
a second layer comprising a porous polymer substrate; and
a third layer comprising a woven or a non-woven fabric; wherein the cross-linked nucleophilic polymer comprises functional groups operative to form a covalent bond with a chemical or biological agent.

14. The article of claim 13, wherein the second layer comprises an antimicrobial agent.

15. A method of manufacturing an article comprising:
disposing a nucleophilic organic polymer on a porous polymer substrate; the porous polymer substrate with the nucleophilic organic polymer disposed thereon forming a first layer; and
cross-linking the nucleophilic organic polymer on a surface or within pores of the porous polymer substrates using a carbamate cross-linking agent; wherein the cross-linked nucleophilic polymer comprises functional groups operative to form a covalent bond with a chemical or biological agent.

16. The method of claim 15, further comprising disposing a second layer upon a surface of the first layer; the second layer comprising a porous polymer substrate.

17. The method of claim 16, further comprising disposing an additive on the second layer; the additive being an antimicrobial agent, an enzyme with activity for neutralizing a chemical and/or a biological agent or a chemical absorbing agents.

18. The method of claim 16, further comprising disposing a third layer upon a surface of the second layer; the third layer being disposed on a surface of the second layer that is opposed to a surface that the first layer is disposed on.

19. The method of claim 18, wherein the third layer comprises a fabric; the fabric being selected from the group consisting of polyamides, polyesters, cotton, aramids, and a combination comprising at least one of the foregoing fabrics.

20. The method of claim 18, wherein the third layer comprises a fabric; the fabric comprising a cotton/polyamide mix in an amount of about 50 parts cotton to about 50 parts polyamide and with a durable water-repellent finish.

21. The method of claim 15, wherein the disposing of the nucleophilic organic polymer on the porous polymer substrate is conducted using a roll mill.

22. The method of claim 15, wherein the disposing of the nucleophilic organic polymer on the porous polymer substrate is conducted using a slot die.

23. An article manufactured by the method of claim 15.
